(19) United States
(12) Patent Application Publication
(10) Pub. No.: US 2017/0203355 A1
(43) Pub. Date: Jul. 20, 2017

(54) METHODS FOR PRODUCING FORGED PRODUCTS AND OTHER WORKED PRODUCTS

(71) Applicant: ARCONIC INC., Pittsburgh, PA (US)

(72) Inventors: Gen Satoh, Murrysville, PA (US); Daniel M. Myers, JR., New Kensington, PA (US); Brandon H. Bodily, Broadview Heights, OH (US)

(21) Appl. No.: 15/407,987

(22) Filed: Jan. 17, 2017

Related U.S. Application Data
(60) Provisional application No. 62/278,766, filed on Jan. 14, 2016.

(51) Int. Cl. B21J 1/00; B23K 10/02; B33Y 50/02; G05B 19/4099; B33Y 10/00; B23K 9/04; B23K 15/00

(52) U.S. Cl. CPC B21J 1/00; B23K 9/044; B23K 10/027; B23K 15/0086; G05B 19/4099; B33Y 10/00; B33Y 50/02; B23K 2203/14

(57) ABSTRACT

Generally, the present disclosure is directed various embodiments to additively manufacture AM preforms to reduce, prevent, and/or eliminate defects that occur in post processing operations (e.g. forging, shot peening, machining, or other post processing operations).

### CROSS-REFERENCE TO RELATED APPLICATIONS

This patent application is a non-provisional of and claims priority to U.S. Provisional Patent Application No. 62/278,766 filed Jan. 14, 2016, which is incorporated herein by reference in its entirety.

### FIELD OF THE INVENTION

Generally, the present disclosure is directed towards additively manufacturing AM preforms to reduce, prevent, and/or eliminate defects that occur in post processing operations (e.g. forging, shot peening, machining, or other post processing operations). More specifically, the present disclosure is directed towards additively manufacturing a metal shaped preform while utilizing a bead and/or path planning deposition strategy to create an additively manufactured metal shaped preform with reduced initiation sites for post processing defects as compared to an AM preform without such deposition strategies, thereby creating a final part with reduced and/or eliminated processing defects (e.g. folds, laps, cold shuts when the operation is forging).

### BACKGROUND

Metal products may be formed into shapes via post processing operations (forging, machining, or other methods). To forge metal products, several successive dies (flat dies and/or differently shaped dies) may be used for each part, with the flat die or the die cavity in a first of the dies being designed to deform the forging stock to a first shape defined by the configuration of that particular die, and with the next die being shaped to perform a next successive step in the forging deformation of the stock, and so on, until the final die ultimately gives the forged part a fully deformed shape. See, U.S. Pat. No. 4,055,975. To machine metal products, a component is shaped or cut into the desired final shape and size by a controlled material-removal process.

### SUMMARY

Broadly, the present patent application relates to improved methods for producing metal products (e.g., machined metal products, worked metal products, forged metal products; other types of hot worked and/or cold worked metal products).

In one aspect, a method is provided comprising: (a) additively manufacturing a metal shaped-preform from an additive manufacturing feedstock; (b) concomitant with (a), using a bead deposition strategy to modify a bead path, whereby the combination of (a) and (b) provide the metal shaped preform configured with a smoothed external surface having non-stepped walls as compared to the metal shaped preform without such bead deposition strategy; and (c) performing at least one post processing operation on the metal shaped preform to form a final formed product, whereby, due to (b), the final formed product has reduced post processing operation defects as compared to without (b).

In some embodiments, the bead deposition strategy comprises path planning of the bead path.

In some embodiments, path planning is selected from the group consisting of: a non-linear build path around the interior of a part build; a non-linear build path around the perimeter of a part build; an overlapping bead deposition in the build direction, when comparing a first AM deposition layer to a subsequent AM deposition layer, wherein each deposition layer is configured from a plurality of beads, such that between the first AM deposition layer and the subsequent AM deposition layer, a subsequent layer bead does not completely overlap with a first layer bead, and combinations thereof.

In some embodiments, the bead deposition strategy comprises path planning, wherein a first bead in a first AM build layer overlaps at least a portion but not entirely with a subsequent bead in a subsequent AM build layer, wherein the subsequent bead is in contact with the first bead.

In some embodiments, the post processing operation is selected from the group consisting of: forging, thermally treating and machining, machining, shot peening, annealing, and combinations thereof.

In some embodiments, the additive manufacturing is completed with a directed energy deposition additive machine.

In some embodiments, the direct energy deposition additive machine is selected from the group consisting of: a Sciaky machine, plasma arc machine, a wire feed AM machine, and combinations thereof.

In some embodiments, the post processing operation is forging and the final formed product is free from forging defects selected from the group consisting of: folds, cavities, and combinations thereof.

In some embodiments, the method includes machining the final forged part to provide a finished part.

In some embodiments, the metal preform comprises at least one of titanium, titanium alloy, titanium aluminide, aluminum, nickel, steel, stainless steel, and combinations thereof.

In some embodiments, the bead deposition strategy is configured in a vertical direction such that the vertical surfaces are free from defect-causing discontinuities in the post processing operation.

In some embodiments, the bead deposition strategy is configured in a horizontal direction such that the horizontal surfaces are free from defect-causing discontinuities in the post processing operation.

In one aspect, a method is provided, comprising: (a) additively manufacturing a metal shaped-preform from an additive manufacturing feedstock using a direct energy deposition additive machine; (b) utilizing path planning deposition strategy to promote a non-stepped perimeter of the metal shaped preform, and (c) forging the metal shaped preform to form a final forged product, whereby via (b) the final forged product is substantially free from forging defects including at least one of: laps, cavities, folds, cold shuts, and combinations thereof.

In some embodiments, path planning further comprises utilizing a modified bead deposition in successive layers of the metal shaped preform such that the bead deposition layers are non-conforming to provide a different build pattern layer-by-layer within the metal shaped preform.

In some embodiments, path planning further comprises utilizing a modified bead deposition in successive layers of the metal shaped preform such that the bead deposition layers are overlapping by less than 100%.

In some embodiments, bead overlap is less than 80% between two beads of successive AM build layers.

In some embodiments, the bead overlap is less than 50% between two beads of successive AM build layers.

In some embodiments, the bead overlap is less than 30% between two beads of successive AM build layers.

In some embodiments, the bead overlap is: less than 100%; less than 90%; less than 80%; less than 70%; less than 60%; less than 50%; less than 40%; less than 30%; less than 20% less than 10%; or less than 5%. In some embodiments, the bead overlap is: greater than 90%; greater than 80%; greater than 70%; greater than 60%; greater than 50%; greater than 40%; greater than 30%; greater than 20% greater than 10%; greater than 5%, or greater than 0 (at least some overlap).

In some embodiments, the metal shaped preform is configured with a smoothed surface, characterized by the absence of jogs and steps in the build height direction, configured in the direction normal from the build plane.

In some embodiments, the path planning deposition strategy is configured in a vertical direction such that the vertical surfaces are free from defect-causing discontinuities in the forging step.

In some embodiments, the path planning deposition strategy is configured in a horizontal direction such that the horizontal surfaces are free from defect-causing discontinuities in the forging step.

In some embodiments, the forging step comprises a single die forging step.

In some embodiments, the metal preform comprises at least one of titanium, titanium alloy, titanium aluminide, aluminum, nickel, steel, and stainless steel.

In some embodiments, the forging step comprises: heating the metal shaped-preform to a stock temperature; and contacting the metal shaped-preform with a forging die.

In some embodiments, after the utilizing step (b), working the metal shaped-preform into a final worked product via at least one of: (i) rolling, (ii) ring rolling, (iii) ring forging, (iv) shaped rolling, (v) extruding, and (vi) combinations thereof.

In some embodiments, after the forging step (c), annealing the final forged product.

In one embodiment, a method includes using additive manufacturing to produce a metal shaped-preform. After the using step (e.g. producing a metal shaped-preform using/via additive manufacturing), the metal shaped-preform may be forged into a final forged product. In one embodiment, the forging step comprises a single die forging step. In some embodiments, a single forging step is represented by a single heat and forge cycle. In some embodiments, the forge cycle includes multiple deformations without a heating cycle between the deformations. In some embodiments, a heat cycle represents heating the material to the specified temperature prior to the forging deformation step. (As a non-limiting example, a hammer press many times has multiple deformations within a single heat cycle). In one embodiment, the metal preform comprises at least one of titanium, aluminum, nickel, steel, stainless steel, and titanium aluminide. In some embodiments, combinations of titanium, aluminum, nickel, steel, stainless steel, and titanium aluminide combined into the preform (i.e. a dual alloy preform build). In one embodiment, the metal shaped-preform may be a titanium alloy. For example, the metal shaped-preform may comprise a Ti-6Al-4V alloy. In another embodiment, the metal shaped-preform may be an aluminum alloy. In yet another embodiment, the metal shaped-preform may be a nickel alloy. In yet another embodiment, the metal shaped-preform may be one of a steel and a stainless steel. In another embodiment, the metal shaped-preform may be a metal matrix composite. In yet another embodiment, the metal shaped-preform may comprise titanium aluminide. For example, in one embodiment, the titanium alloy may include at least 48 wt. % Ti and at least one titanium aluminide phase, wherein the at least one titanium aluminide phase is selected from the group consisting of Ti₃Al, TiAl and combinations thereof. In another embodiment, the titanium alloy includes at least 49 wt. % Ti. In yet another embodiment, the titanium alloy includes at least 50 wt. % Ti. In another embodiment, the titanium alloy includes 5-49 wt. % aluminum. In yet another embodiment, the titanium alloy includes 30-49 wt. % aluminum, and the titanium alloy comprises at least some TiAl. In yet another embodiment, the titanium alloy includes 5-30 wt. % aluminum, and the titanium alloy comprises at least some Ti₃Al.

The forging step may comprise heating the metal shaped-preform to a stock temperature, and bringing the metal shaped-preform to the forging die which has been heated separately to the desired temperature, and contacting the metal shaped-preform with a forging die. In one embodiment, the die may be at a temperature that is nominally equal to the metal shaped-preform temperature (e.g. isothermal forging). In another embodiment, when the contacting step is initiated, the forging die may be a temperature that is at least 10° F. lower than the stock temperature. In another embodiment, when the contacting step is initiated, the forging die is a temperature that is at least 25° F. lower than the stock temperature. In yet another embodiment, when the contacting step is initiated, the forging die is a temperature that is at least 50° F. lower than the stock temperature. In another embodiment, when the contacting step is initiated, the forging die is a temperature that is at least 100° F. lower than the stock temperature. In yet another embodiment, when the contacting step is initiated, the forging die is a temperature that is at least 200° F. lower than the stock temperature.

In one aspect, the final forged product is a component for an engine. In one embodiment, the final forged product is a blade for a jet engine. In one embodiment, the final forged product is a component for a vehicle (e.g. land, water, air, and combinations thereof). In one embodiment, the final forged product is a structural component of a vehicle. In another embodiment, the final forged product is a structural aerospace component (e.g. spar, rib, attachment fitting, window frame, landing gear, etc.). In another embodiment, the final forged product is a structural component for a land-based turbine application. In another embodiment, the final forged product is a component for a land-based and/or water-based vehicle. In another embodiment, as described below, the final forged product is an engine containment ring.

In another aspect, a method comprises using additive manufacturing to produce a metal shaped-preform, and concomitant to, or after the using step, working the metal shaped-preform into a final worked product via at least one of: (i) rolling, (ii) ring rolling, (iii) ring forging, (iv) shape rolling, (v) extruding, and (vi) combinations thereof. In one embodiment, the working is rolling. In another embodiment, the working is ring rolling. In yet another embodiment, the working is ring forging. In another embodiment, the working is shaped rolling. In yet another embodiment, the working is extruding. Without being bound by a particular mechanism or theory, it is believed that one such reason for producing an additively manufactured billet for these processes is to enable (e.g. configure) bi-alloy or multi-alloy starting stock for rolling, forging, or extrusion operations. In some embodiments, the bi-alloy or multi-alloy starting stock is unachievable using conventional billet and starting stock methods.

In another aspect, a method comprises using additive manufacturing to produce a metal shaped-preform, and concomitant to, or after the using step, machining the preform to a desired geometry. Heat treatment of the preform may occur prior to machining to reduce residual stress within the part, enhance machinability and/or enhance mechanical properties of the material. Without being bound by a particular mechanism or theory, it is believed that one such reason for producing an additively manufactured billet for these processes is to enable (e.g. configure) bi-alloy or multi-alloy starting stock for machining operations. Additive manufacturing of the preform may enable greater flexibility over the distribution of the different alloys in a multi-alloy stock than conventional methods (lamination, etc.)

In some embodiments, when the metal shaped-preform comprises a Ti-6Al-4V alloy, the forging step comprises heating the metal shaped-preform to a stock temperature, and contacting the metal shaped-preform with a forging die. In this regard, the contacting step comprises deforming the metal shaped-preform via the forging die. In one embodiment, the contacting step comprises deforming the metal shaped-preform via the forging die to realize a true strain of from 0.05 to 1.10 in the metal shaped-preform. In another embodiment, the contacting step comprises deforming the metal shaped-preform via the forging die to realize a true strain of at least 0.10 in the metal shaped-preform. In yet another embodiment, the contacting step comprises deforming the metal shaped-preform via the forging die to realize a true strain of at least 0.20 in the metal shaped-preform. In another embodiment, the contacting step comprises deforming the metal shaped-preform via the forging die to realize a true strain of at least 0.25 in the metal shaped-preform. In yet another embodiment, the contacting step comprises deforming the metal shaped-preform via the forging die to realize a true strain of at least 0.30 in the metal shaped-preform. In another embodiment, the contacting step comprises deforming the metal shaped-preform via the forging die to realize a true strain of at least 0.35 in the metal shaped-preform. In another embodiment, the contacting step comprises deforming the metal shaped-preform via the forging die to realize a true strain of not greater than 1.00 in the metal shaped-preform. In yet another embodiment, the contacting step comprises deforming the metal shaped-preform via the forging die to realize a true strain of not greater than 0.90 in the metal shaped-preform. In another embodiment, the contacting step comprises deforming the metal shaped-preform via the forging die to realize a true strain of not greater than 0.80 in the metal shaped-preform. In yet another embodiment, the contacting step comprises deforming the metal shaped-preform via the forging die to realize a true strain of not greater than 0.70 in the metal shaped-preform. In another embodiment, the contacting step comprises deforming the metal shaped-preform via the forging die to realize a true strain of not greater than 0.60 in the metal shaped-preform. In yet another embodiment, the contacting step comprises deforming the metal shaped-preform via the forging die to realize a true strain of not greater than 0.50 in the metal shaped-preform. In another embodiment, the contacting step comprises deforming the metal shaped-preform via the forging die to realize a true strain of not greater than 0.45 in the metal shaped-preform. As mentioned above, the forging step may comprise heating the metal shaped-preform to a stock temperature.

In one aspect, the forging step comprises heating the metal-shaped preform to a stock temperature. In one approach, the metal shaped preform is heated to a stock temperature of from 850° C. to 978° C. In one embodiment, the metal shaped preform is heated to a stock temperature of at least 900° C. In another embodiment, the metal shaped preform is heated to a stock temperature of at least 950° C. In yet another embodiment, the metal shaped preform is heated to a stock temperature of at least 960° C. In another embodiment, the metal shaped preform is heated to a stock temperature of not greater than 975° C. In yet another embodiment, the metal shaped preform is heated to a stock temperature of not greater than 973° C.

In one aspect, the step of using additive manufacturing to produce a metal shaped-preform comprises adding material, via additive manufacturing, to a building substrate thereby producing the metal shaped-preform. In some embodiments, a substrate is utilized in additive manufacturing onto which layers are built and/or deposited in order to produce the desired geometry of an additive manufacturing form/product. In one embodiment, the additively manufactured deposit or build is removed from the substrate and comprises the metal shaped-preform. In another embodiment, the substrate or portions of the substrate remains a part of the metal-shaped preform. In one embodiment, the material is a first material having a first strength and wherein the building substrate is comprised of a second material having a second strength. In some embodiments, the first material has a first fatigue property and the second material has a second fatigue property. As a non-limiting example, a layer of a first material having low strength and high toughness could be added, via additive manufacturing, to a building substrate comprised of a second material having high strength and low toughness, thereby producing a metal-shaped preform useful, for example, in ballistic applications. In some embodiments, substrates are selected/tailored/chosen for reasons including (but not limited to): geometry, microstructure, material properties and characteristics, chemistry, cost, amongst others based on (e.g. in order to promote) the design specifications of the finished product. For example, the use of a rolled plate or other wrought substrate allows for reduced and/or minimal work to be utilized in those areas of the metal shaped-preform where the substrate resides due to the substrate already exhibiting forged or wrought properties. In some embodiments, the material and substrate are chosen to be the same.

In one embodiment, the building substrate comprises a first ring of a first material, and the using step comprises adding a second material, via additive manufacturing, to the first ring thereby forming a second ring, wherein the second ring is integral with the first ring. In this regard, rings consisting of multi-materials are produced.

In another aspect, the method includes, after the forging step, annealing the final forged product. In one embodiment, when the metal shaped-preform comprises a Ti-6Al-4V alloy, the annealing step comprises heating the final forged product to a temperature of from about 640° C. to about 816° C. In another embodiment, when the metal shaped-preform comprises a Ti-6Al-4V alloy, the annealing step comprises heating the final forged product to a temperature of from about 670° C. to about 750° C. In yet another embodiment, when the metal shaped-preform comprises a Ti-6Al-4V alloy, the annealing step comprises heating the final forged product to a temperature of from about 700° C. to about 740° C. In another embodiment, when the metal shaped-preform comprises a Ti-6Al-4V alloy, the annealing step comprises heating the final forged product to a temperature of about 732° C.

### BRIEF DESCRIPTION OF THE DRAWINGS

FIG. 1 is a schematic illustration of one embodiment of a method of producing a final forged product.

FIG. 2 is a schematic illustration of one embodiment of a method of producing a final forged product, wherein the method includes an optional annealing step.

FIGS. 3-4 are charts illustrating data of Example 1.

FIG. 5 is a schematic illustration of one embodiment of a method of producing a final forged product, wherein the final forged product includes an integral building substrate.

FIG. 6 is a schematic illustration of another embodiment of a method of producing a final forged product, wherein the final forged product includes an integral building substrate.

FIG. 7 is an illustration showing the transverse orientation and longitudinal orientations of a cylindrical preform.

FIG. 8 is a micrograph of one embodiment of an as-built Ti-6Al-4V metal shaped-preform, taken in the transverse direction.

FIG. 9 is a micrograph of one embodiment of a preheated Ti-6Al-4V metal shaped-preform, taken in the transverse direction.

FIG. 10 is a micrograph of one embodiment of a Ti-6Al-4V final forged product, taken in the transverse direction.

FIG. 11 is a micrograph of one embodiment of an annealed Ti-6Al-4V final forged product, taken in the transverse direction.

FIG. 12 depicts an embodiment of a method in accordance with the instant disclosure.

FIG. 13 depicts a side-by-side comparison of an as-made preform compared to an embodiment of a workable/forgeable preform configured with a smooth profile via path planning, in accordance with one or more methods of the instant disclosure.

FIG. 14 depicts two contrasting examples of an additively manufactured build (AM preform) utilizing a conventional approach (left) and an additively manufactured build (AM preform) utilizing path planning (right), in accordance with one or more embodiments of the instant disclosure. On both left and right schematic views in FIG. 14, a draft angle is depicted superimposed onto the AM preform. More specifically, with the figure on the left, typical AM build configuration shows stepped features in the vertical (build direction) perpendicular to the deposition plane, while the figure on the right illustrates that utilizing path planning eliminates steps in the vertical orientation (and enables overlap ratio of less than 1:1 between successive build layers). In the figure on the left, the large number of discontinuities comparing the external surface with the draft angle/build profile is believed to cause forging defects (e.g. cavities and/or folds) in the forged product. In contrast, the path planning embodiment (right figure), illustrates that path planning is configured with additively manufacturing to configure the AM preform with a specifically designed external deposits and internal deposits to provide a smooth surface with drafted angles and to fill the forging die cavity during part forming processes. With one or more embodiments of path planning, the AM preform closely conforms to the build profile/draft angle for the AM build design.

FIG. 15 depicts an embodiment of the present method, whereby path planning is utilized to eliminate discontinuities in an AM preform which is configured to undergo further post processing operations (e.g. forging, machining, shot peening, etc.). The image on the left depicts a schematic of typical deposition pattern without path planning, where the individual parallel rectangular blocks represent individual AM bead depositions. In contrast, the image in the center depicts a photograph of a part additively manufactured while employing a path planning embodiment of the instant disclosure (e.g. where individual beads are visually observed in a build pattern that is not a series of parallel bead depositions; but rather, configured in an x-y-z direction and with partial bead overlaps to enable AM build of an AM preform which closely corresponds to the final part, after the post processing operation(s) are performed). The image on the right is an overlap of the conventional build process with the part build utilizing path planning, where the number of discontinuities between the conventional build and reduction in discontinuities with path planning is illustrated with a plurality of stepped edges from the schematic view (conventional build path) that extend beyond the AM preform (built via path planning).

### DETAILED DESCRIPTION

Reference will now be made in detail to the accompanying drawings, which at least assist in illustrating various pertinent embodiments of the new technology provided for by the present disclosure.

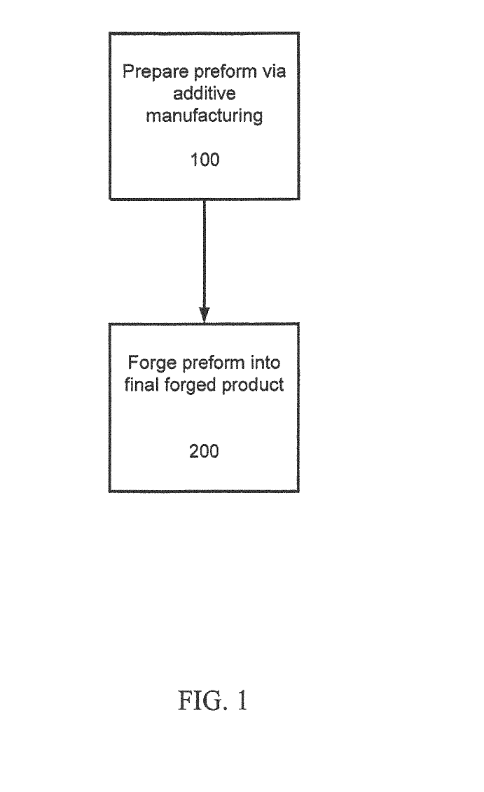

One embodiment of the new method for producing forged metal products is illustrated in FIG. 1. In the illustrated embodiment, the method includes a step of preparing (100) a metal shaped-preform via additive manufacturing, followed by forging (200) the metal shaped-preform into a final forged product (e.g., a net-shape product or near net-shape product). After the forging step (200), the final forged product may require no additional machining or other processing steps, thus facilitating a lower total cost of manufacturing. Furthermore, the final forged product may realize improved properties (e.g., relative to a pure additively manufactured component). Some non-limiting examples of some properties that may be improved in the final forged product (as compared to an AM component with no forging) include: fatigue performance, ability to perform non-destructive evaluation including ultrasonic and radiographic inspection, static strength, ductility, and combinations thereof.

In some embodiments, the additive manufacturing step (100) prepares the metal shaped-preform. As used herein, “additive manufacturing” means a process of joining materials to make objects from 3D model data, usually layer upon layer, as opposed to subtractive manufacturing methodologies, as defined in ASTM F2792-12a for Standard Terminology for Additively Manufacturing Technologies. The metal shaped preform may be manufactured via any appropriate additive manufacturing technique described in this ASTM standard, such as binder jetting, directed energy deposition, material extrusion, material jetting, powder bed fusion, digital printing techniques, or sheet lamination, among others. In some embodiments, precisely designed and/or tailored products can be produced.

In some embodiments, the metal shaped-preform produced by the additive manufacturing step (100) is made from any metal suited for both additive manufacturing and forging, including, for example metals or alloys of titanium, aluminum, nickel (e.g., INCONEL), steel, and stainless steel, among others. An alloy of titanium is an alloy having titanium as the predominant alloying element. An alloy of aluminum is an alloy having aluminum as the predominant alloying element. An alloy of nickel is an alloy having nickel as the predominant alloying element. An alloy of steel is an alloy having iron as the predominant alloying element, and at least some carbon. An alloy of stainless steel is an alloy having iron as the predominant alloying element, at least some carbon, and at least some chromium. In one embodiment, the metal shaped-preform is an intermediate product in the form of a precursor to a blade for a jet engine.

Still referring to FIG. 1, once the metal shaped-preform is formed, the metal shaped-preform is forged (200). In one embodiment, the forging step (200) uses a single forging step to die forge the metal shaped-preform into the final forged product. In one embodiment, the forging step (200) uses a single blocker (or metal shaped-preform) to die forge the metal shaped-preform into the final forged product. In some embodiments, forging (200) the metal shaped-preform, configures the final forged product into realizing improved properties, such as improved porosity (e.g., less porosity), improved surface roughness (e.g., less surface roughness, i.e., a smoother surface), and/or better mechanical properties (e.g., improved surface hardness), among others.

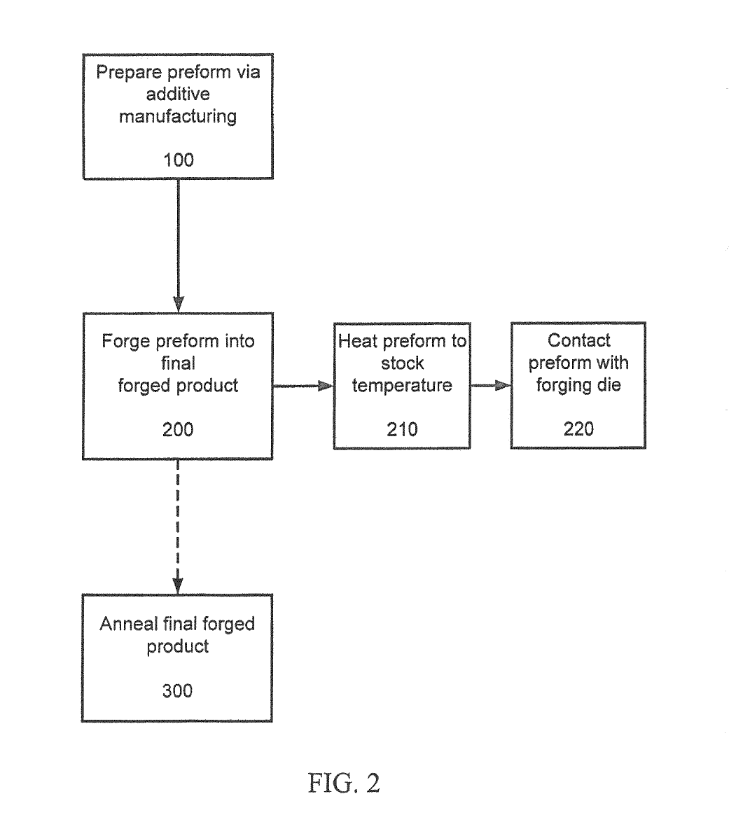

Referring now to FIG. 2, in one embodiment, during the forging step (200), the dies and/or tooling of the forging process is at a lower temperature than the metal-shaped preform. In this regard, the forging step includes heating the metal shaped-preform to a stock temperature (the target temperature of the preform prior to the forging) (210), and contacting the metal shaped-preform with a forging die (220). In one embodiment, when the contacting step (220) is initiated, the forging die is a temperature that is at least 10° F. lower than the stock temperature. In another embodiment, when the contacting step (220) is initiated, the forging die is a temperature that is at least 25° F. lower than the stock temperature. In yet another embodiment, when the contacting step (220) is initiated, the forging die is a temperature that is at least 50° F. lower than the stock temperature. In another embodiment, when the contacting step (220) is initiated, the forging die is a temperature that is at least 100° F. lower than the stock temperature. In yet another embodiment, when the contacting step (220) is initiated, the forging die is a temperature that is at least 200° F. lower than the stock temperature. In another embodiment, when the contacting step (220) is initiated, the forging die is a temperature that is at least 300° F. lower than the stock temperature. In yet another embodiment, when the contacting step (220) is initiated, the forging die is a temperature that is at least 400° F. lower than the stock temperature. In another embodiment, when the contacting step (220) is initiated, the forging die is a temperature that is at least 500° F. lower than the stock temperature. In some embodiments, when the contacting step is initiated, the forging die completes an isothermal forging. In one aspect, after the forging step (200) the final forged product is annealed (300). In some embodiments, the annealing step is configured to achieve desired properties in the final forged product. In some embodiments, the annealing step (300) facilitates the relieving of residual stress in the metal-shaped preform due to the forging step (200). In one approach, the metal-shaped preform comprises a Ti-6Al-4V alloy and the annealing step (300) comprises heating the final forged product to a temperature of from about 640° C. (1184° F.) to about 816° C. (1500° F.) and for a time of from about 0.5 hour to about 5 hours. In one embodiment, the annealing step (300) comprises heating the final forged product to a temperature of at least about 640° C. (1184° F.). In another embodiment, the annealing step (300) comprises heating the final forged product to a temperature of at least about 670° C. (1238° F.). In yet another embodiment, the annealing step (300) comprises heating the final forged product to a temperature of at least about 700° C. (1292° F.). In another embodiment, the annealing step (300) comprises heating the final forged product to a temperature of not greater than about 760° C. (1400° F.). In yet another embodiment, the annealing step (300) comprises heating the final forged product to a temperature of not greater than about 750° C. (1382° F.). In another embodiment, the annealing step (300) comprises heating the final forged product to a temperature of not greater than about 740° C. (1364° F.). In yet another embodiment, the time is at least about 1 hour. In another embodiment, the time is at least about 2 hours. In yet another embodiment, the time is not greater than about 4 hours. In another embodiment, the time is not greater than about 3 hours. In yet another embodiment, the annealing step (300) comprises heating the final forged product to a temperature of about 732° C. (1350° F.) and for a time of about 2 hours.

In some embodiments, the contacting step (220) comprises applying a sufficient force to the metal shaped-preform via the forging die to realize a pre-selected amount of true strain in the metal shaped-preform. In some embodiments, the pre-selected amount of strain is varied throughout the finished forging to accommodate, for example, the use of a wrought substrate plate, etc. In one embodiment, the applying a sufficient force step comprises deforming the metal shaped-preform via the forging die. As used herein “true strain” (εₜᵣᵤₑ) is given by the formula:

εₜᵣᵤₑ=ln(L/L₀)

Where L₀ is initial length of the material and L is the final length of the material. In one embodiment, the contacting step (220) comprises applying sufficient force to the metal shaped-preform via the forging die to realize a true strain of from about 0.05 to about 1.10 in the metal shaped-preform. In another embodiment, the contacting step (220) comprises applying sufficient force to the metal shaped-preform via the forging die to realize a true strain of at least 0.10 in the metal shaped-preform. In another embodiment, the contacting step (220) comprises applying sufficient force to the metal shaped-preform via the forging die to realize a true strain of at least 0.20 in the metal shaped-preform. In yet another embodiment, the contacting step (220) comprises applying a sufficient force to the metal shaped-preform via the forging die to realize a true strain of at least 0.25 in the metal shaped-preform. In another embodiment, the contacting step (220) comprises applying sufficient force to the metal shaped-preform via the forging die to realize a true strain of at least 0.30 in the metal shaped-preform. In yet another embodiment, the contacting step (220) comprises applying sufficient force to the metal shaped-preform via the forging die to realize a true strain of at least 0.35 in the metal shaped-preform. In another embodiment, the contacting step (220) comprises applying sufficient force to the metal shaped-preform via the forging die to realize a true strain of not greater than 1.00 in the metal shaped-preform. In yet another embodiment, the contacting step (220) comprises applying sufficient force to the metal shaped-preform via the forging die to realize a true strain of not greater than 0.90 in the metal shaped-preform. In another embodiment, the contacting step (220) comprises applying sufficient force to the metal shaped-preform via the forging die to realize a true strain of not greater than 0.80 in the metal shaped-preform. In yet another embodiment, the contacting step (220) comprises applying sufficient force to the metal shaped-preform via the forging die to realize a true strain of not greater than 0.70 in the metal shaped-preform. In another embodiment, the contacting step (220) comprises applying sufficient force to the metal shaped-preform via the forging die to realize a true strain of not greater than 0.60 in the metal shaped-preform. In yet another embodiment, the contacting step (220) comprises applying sufficient force to the metal shaped-preform via the forging die to realize a true strain of not greater than 0.50 in the metal shaped-preform. In another embodiment, the contacting step (220) comprises applying sufficient force to the metal shaped-preform via the forging die to realize a true strain of not greater than 0.45 in the metal shaped-preform. In yet another embodiment, the contacting step (220) comprises applying sufficient force to the metal shaped-preform via the forging die to realize a true strain of about 0.40 in the metal shaped-preform.

In one embodiment, the metal shaped-preform is a low ductility material, such as a metal matrix composite or an intermetallic material. In one embodiment, the metal shaped-preform is titanium aluminide.

Without being bound by a particular mechanism or theory, it is believed that using the new processes disclosed herein facilitates more economical production of final forged products from such low ductility materials. As a non-limiting example, with the various embodiments of the foregoing methods, low ductility material(s) are forged using dies and/or tooling that are at a lower temperature than the low ductility material. Thus, in one embodiment, the forging is absent of isothermal forging (i.e., the forging process does not include isothermal forging), and thus can include any of the stock temperature versus die temperature differentials noted previously.

In one aspect, the metal shaped preform is a titanium (Ti) alloy, and thus includes titanium as the predominant alloying element. In one embodiment, a titanium alloy includes at least 48 wt. % Ti. In another embodiment, a titanium alloy includes at least 49 wt. % Ti. In yet another embodiment, a titanium alloy includes at least 50 wt. % Ti. In one embodiment, the titanium alloy comprises one or more titanium aluminide phases. In one embodiment, the titanium aluminide phase(s) is/are one or more of Ti₃Al and TiAl. In some embodiments, when titanium aluminides are present, the titanium alloy may include 5-49 wt. % aluminum. In one embodiment, the titanium aluminide phase(s) comprise TiAl. In one embodiment, the titanium alloy includes 30-49 wt. % aluminum, and the titanium alloy comprises at least some TiAl. In one embodiment, the titanium aluminide phase(s) comprises Ti₃Al. In one embodiment, the titanium alloy includes 5-30 wt. % aluminum, and the titanium alloy comprises at least some Ti₃Al. In one embodiment, the titanium alloy comprises aluminum and vanadium.

In one embodiment, the metal shaped preform comprises a Ti-6Al-4V alloy (a titanium alloy having about 6 wt. % aluminum and about 4 wt. % vanadium). In this regard, the Ti-6Al-4V preforms are heated to a stock temperature of from about 850° C. (1562° F.) to about 978° C. (1792° F.). In one embodiment, the Ti-6Al-4V preforms are heated to a stock temperature of at least 900° C. (1652° F.). In another embodiment, the Ti-6Al-4V preforms are heated to a stock temperature of at least 925° C. (1697° F.). In another embodiment, the Ti-6Al-4V preforms are heated to a stock temperature of at least 950° C. (1742° F.). In yet another embodiment, the Ti-6Al-4V preforms are heated to a stock temperature of at least 960° C. (1760° F.). In another embodiment, the Ti-6Al-4V preforms are heated to a stock temperature of not greater than 975° C. (1787° F.). In yet another embodiment, the Ti-6Al-4V preforms are heated to a stock temperature of not greater than 973° C. (1783° F.).

In some embodiments, the final forged product is used in the aerospace, aviation, and/or medical industries. In some embodiments, the final forged product is, for example, a turbine or blade. In one embodiment, the final forged product is a blade for a jet engine.

In some embodiments, after the additive manufacturing step (100), the metal shaped-preform is forged (200) to create a final forged product. In other embodiments, after the additive manufacturing step (100), the metal shaped-preform is processed via other forms of working (e.g., hot working) to create a final worked product 710.

In some embodiments, the working of the metal shaped-preform includes at least one of: rolling 710, ring rolling 720, ring forging 730, shaped rolling 740, and/or extruding 750 to create the final worked product. In some embodiments, the final worked product realizes improved properties, such as improved porosity (e.g., less porosity), improved surface roughness (e.g., less surface roughness, i.e., a smoother surface), and/or better mechanical properties (e.g., improved surface hardness), among others. In some embodiments, the final worked product realizes a predetermined shape. In some embodiments, the metal shaped-preform is ring rolled, ring forged and/or extruded (e.g., forced through a die) to create a hollow final worked product. In some embodiments, the metal shaped-preform is rolled to produce a final worked product that realizes improved porosity. In some embodiments, the metal shaped-preform is shape rolled to produce a final worked product that realizes a predetermined shape (e.g., a curve having a specified radius).

As used herein, “ring rolling” means the process of rolling a ring of smaller diameter (e.g., a first ring having a first diameter) into a ring of larger diameter (e.g., a second ring having a second diameter, wherein the second diameter is larger than the first diameter), optionally with a modified cross section (e.g., a cross sectional area of the second ring is different than a cross sectional area of the first ring) by the use of two rotating rollers, one placed in the inside diameter of the ring and the second directly opposite the first on the outside diameter of the ring.

As used herein, “ring forging” means the process of forging a ring of smaller diameter (e.g., a first ring having a first diameter) into a ring of larger diameter (e.g., a second ring having a second diameter, wherein the second diameter is larger than the first diameter), optionally with a modified cross section (e.g., a cross sectional area of the second ring is different than a cross sectional area of the first ring) by squeezing the ring between two tools or dies, one on the inside diameter and one directly opposite on the outside diameter of the ring.

As used herein, “shaped rolling” means the process of shaping or forming by working the piece (i.e., the metal shaped-preform) between two or more rollers, which may or may not be profiled, to impart a curvature or shape to the work piece (i.e., the metal shaped-preform).

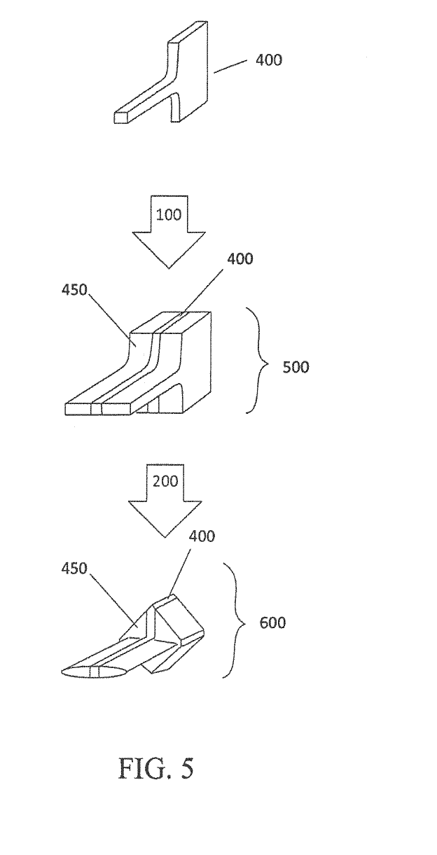

In some embodiments, the step of preparing the metal shaped-preform via additive manufacturing (100) includes incorporating a building substrate into the metal shaped-preform. Referring now to FIG. 5, one embodiment of incorporating a building substrate (400) into the metal shaped-preform (500) is shown. In the illustrated embodiment, material (450) is added to a building substrate (400) via additive manufacturing (100) to produce the metal shaped-preform (500).

As used herein, “building substrate” and the like means a solid material (substrate) that is incorporated into a metal shaped-preform. In some embodiments, the metal shaped-preform (500), which includes the building substrate (400), is forged (200) into a final forged product (600). Thus, in some embodiments, the final forged product (600) includes the building substrate (400) as an integral piece. In some embodiments, the substrate does not need to be shaped such that it resembles and/or mimics the geometry of the desired deposit or metal shaped-preform. In some embodiments, the substrate is a rectangular plate on which the additive manufacturing is performed and is machined or otherwise shaped to the desired geometry after additive manufacturing has been performed. In some embodiments, the substrate is a forging, extrusion, and/or any other material upon which additive manufacturing can be performed. In some embodiments, additional processing of the metal shaped-preform is performed.

In some embodiments, additional processing includes machining prior to or subsequent to the forging step.

In some embodiments, additional processing includes wire electrical discharge machining (wire EDM) prior to or subsequent to the forging step.

In some embodiments, additional processing includes surface finishing prior to or subsequent to the forging step.

In some embodiments, additional processing includes water jet cutting, saw cutting, or flame cutting prior to or subsequent to the forging step.

Without being bound by a particular mechanism or theory, it is believed that certain methods of additive manufacturing result in a characteristic topography in the metal shaped-preform (e.g. surface undulations and/or ridges).

As non-limiting examples, material extrusion and directed energy deposition are two such classes of additive manufacturing that include start, stop, and bead topography characteristics in the final formed additive part. As used herein, “bead” means a continuous deposit of fused metal (e.g. in an additive manufacturing process).

As used herein, “directed energy deposition” refers to an additive manufacturing process in which a focused thermal energy is used to fuse materials by melting as they are being deposited. Non-limiting examples of directed energy deposition include Sciaky, plasma arc, and other wire feed methods.

As used herein, “material extrusion” refers to an additive manufacturing process in which material is selectively dispensed through a nozzle or orifice.

As used herein, a “workable preform” means a preform made via additive manufacturing that has suitable characteristics (e.g. acceptable surface finish and/or geometric features) sufficient to undergo working (e.g. hot working).

As used herein, a “forgeable preform” means a preform made via additive manufacturing that has suitable characteristics (e.g. acceptable surface finish and/or geometric features) sufficient to undergo forging.

In some embodiments, the specifications for a workable preform and/or forgeable preform with an acceptable surface finish and/or geometric features are dependent on the final part geometry (among other variables). In some embodiments, the preform is configured to be free of features that would restrict the flow of metal. In some embodiments, corners on the preforms are configured with appropriate radii (e.g. rounded corners) sufficient for subsequent working to form a worked product (e.g. final forged product).

In some embodiments, the workable preform is configured via one or more embodiments of the instant disclosure, to be substantially free from defects and/or other features (e.g. cracks, gaps, nicks, gouges, sawing serrations, rough portions, ridges, and/or uneven surfaces and other features along at least a portion of the surface) that interrupt a smooth working and/or forging surface. In some embodiments, the workable preform is configured via one or more embodiments of the instant disclosure, to be substantially free from defects and/or other features such that, when worked (or forged) the resulting final worked product (or final forged product) is substantially free from defects (e.g. folds, laps, cavities, non-fill, underfill, and/or other defects).

Some non-limiting examples of defects in the worked final product and/or forged final product include: folds, laps, and/or shuts (e.g. cold shuts). As used herein, “fold” means a forging defect caused by folding the metal back on its own surface during its flow in the die cavity. As used herein, “lap” means a surface irregularity appearing as a fissure or opening, caused by the folding over of hot metal, fins or sharp corners and by subsequent rolling or forging (but not welding) of these into the surface. As used herein, “shuts” are faults produced in a forging by incorrect tool design or incorrect flow of metal that results in the formation of a crack in the forging surface. As used herein, “cold lap” means a flaw that results when a workpiece fails to fill the die cavity during the first forging. As used herein, “seam” means a formation caused as subsequent dies force metal over a gap to leave a seam on the workpiece surface. As used herein, a “cold shut” is a defect (such as lap) that forms whenever metal folds over itself during forging. As a non-limiting example, cold shuts can occur where vertical and horizontal surfaces intersect.

Without being bound by a particular mechanism or theory, these defects can be attributed to surface discontinuities, sharp corners and/or internal features restricting metal flow or otherwise result in improper distribution of the metal during a working operation (e.g. forging). Thus, in accordance with one or more of the embodiments of the instant disclosure, prior to forging, if defects are observed in the metal-shaped preform they are addressed to provide a suitable workable preform configured for further working (e.g. forging). This can be done by mechanically smoothing the surface or removing the defect. Mechanical grinding is a typical operation that is used to prepare preforms and blockers for the forging operation.

In one embodiment, the workable perform (e.g. forgeable perform) is quantified via profilometry techniques (e.g. including contact and/or non-contact analytical methods).

In one embodiment, the workable perform (e.g. forgeable perform) is quantified by measuring the depth to width ratio of the valleys along a portion of the surface of the metal shaped perform.

In one embodiment, the workable perform (e.g. forgeable perform) is quantified by measuring the surface roughness (R_{A}) along at least a portion of the surface of the metal shaped perform.

In some embodiments, the surface roughness is measured via analytical techniques that are contact methods. In some embodiments, the surface roughness is measured via analytical techniques that are non-contact methods (e.g. blue light scans or white light scans, to name a few).

In some embodiments, via the additive manufacturing step, the surface of additively manufactured components can be rough (e.g. a plurality of raised ridges indicative of the bead deposition path), or have a periodic or random surface texture, roughness, or morphology, due to the layer-by-layer and bead-by-bead deposition technique used by many of the additive manufacturing technologies.

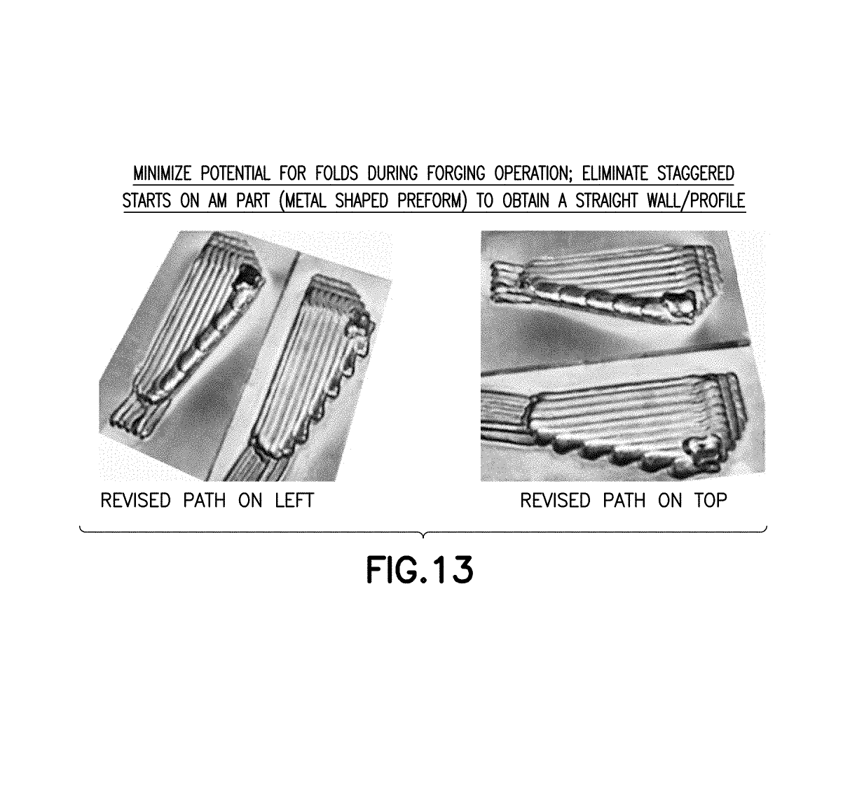

In some embodiments, the method includes configuring the using additive manufacturing step to include deposition strategies to modify the bead deposition in order to promote a modified metal shaped-preform configured with a smooth surface and/or continuous walls (non-stepped walls). Referring to FIG. 13, there are two photographs contrasting the surface and profile between a deposit that utilizes a path planning technique and deposits that utilize conventional additive manufacturing.

In some embodiments, the exterior surface or profile of additively manufactured components is rough, or has a periodic or random surface morphology, due to the bead-by-bead deposition technique used by many of the additive manufacturing technologies. In some embodiments, as adjacent beads are deposited or melted next to each other to produce a layer of an additively manufactured part, they often need to be staggered or be different lengths in order to produce the desired layer geometry. In some embodiments, this results in steps or jogs in the external profile of the layer which is dependent on the bead width and overlap between adjacent beads.

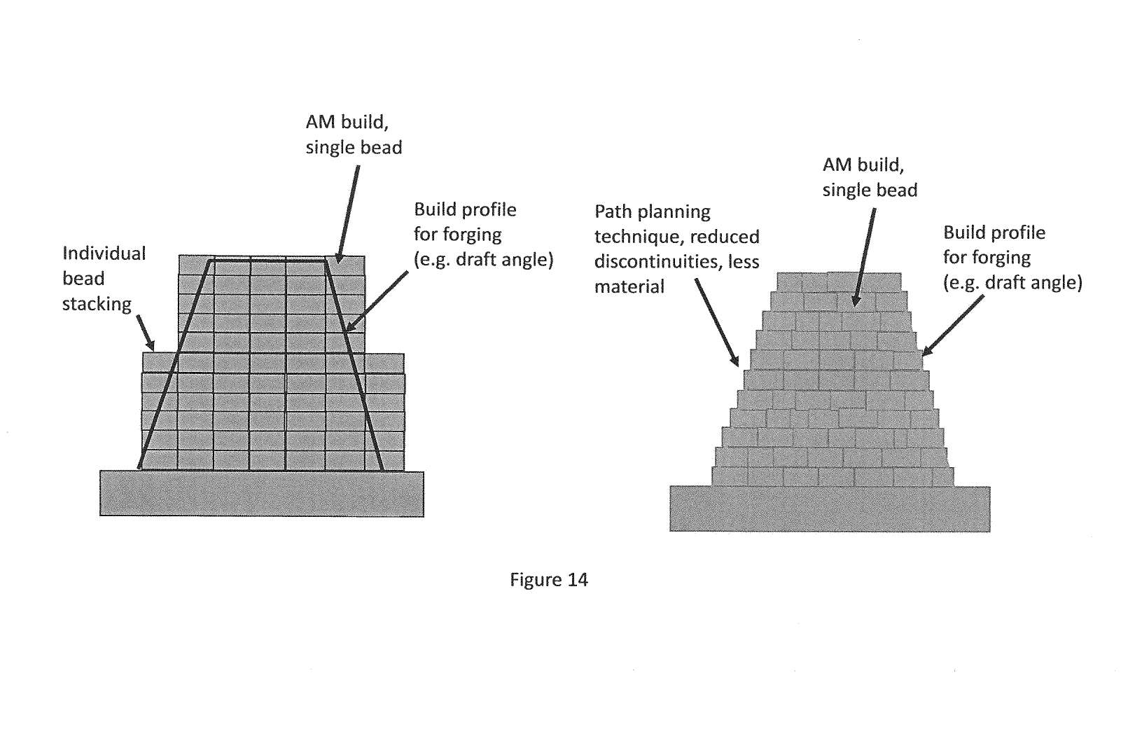

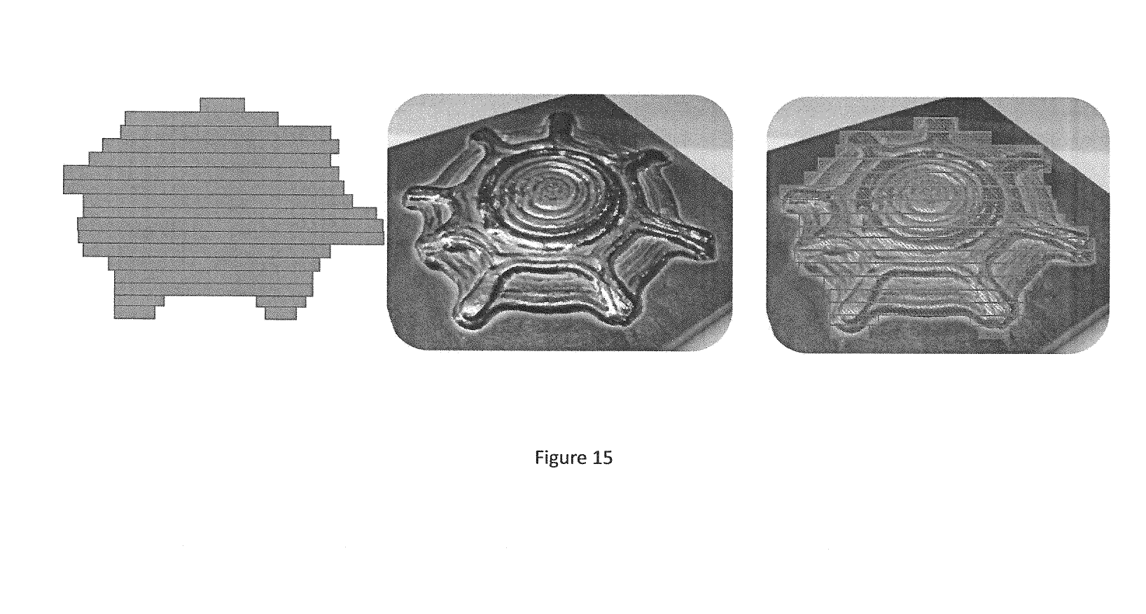

The steps or jogs in the deposit need to be considered across the entire external surface of the forging geometry. The steps or jogs, as described previously, pertain primarily to the build plane of the preform. For a successful forging, a smooth surface, free from jogs and steps is required in the build height direction (e.g. direction normal from the build plane), too. As the deposits build height, perpendicular to the deposition plane, steps or jogs in the material will result in the previously described forging defects such as laps, folds, cold shuts, etc. Path planning can be applied in the vertical direction as well to ensure vertical surfaces are free from defect-causing discontinuities. In some embodiments, this is accomplished through appropriate path planning to adjust the stagger and overlap of beads deposited in successive layers such as to ensure vertical transitions that appropriately match the desired contour of the preform without significant discontinuities, thereby eliminating (or reducing) the steps and/or jogs created by conventional techniques. An example of a necessary feature in a forging preform enabled by this approach is the creation of a draft angle. Draft is the necessary taper on the side of a forging to allow removal from dies. The draft angle is a measure of that angle, expressed in degrees, given to the sides of the forging impression and preform. In the vertical orientation, path planning is configured to enable the production circular features and/or radii on the upper surface of preforms that facilitate proper metal movement and avoidance of forging defects. Examples of one or more of these aforementioned embodiments is depicted in greater detail in FIGS. 14-15. As such, one or more embodiments of path planning in the vertical direction make configured during additive manufacturing to enable a more appropriate geometry in the AM preform, to thereby reduce defects during the forging process. In some embodiments, the utilization of path planning reduces required material (AM feedstock) needed to produce the AM preform, thereby reducing material requirements and cost of the AM preform.

In one or more embodiments of the instant disclosure, the additive manufacturing depositions are planned in order to reduce, prevent, and/or eliminate the stepped nature of the exterior wall of the deposit. In one embodiment, this is achieved through the addition of at least one bead (e.g. a single bead or multiple profile beads per layer that follows the profile of the exterior wall of the desired geometry and is thus not necessarily in line with, parallel to, or similar in shape to deposit paths used toward the interior of the layer. In some embodiments, beads which are used to create the interior portions of the layer intersect with or otherwise connect with the exterior profile bead with some overlap to ensure that no voids or cavities or underfilled areas are created in the layer. In some embodiments, exterior profile beads are configured parallel to or similar in shape to interior beads.

In some embodiments, the stagger and/or overlap of the interior beads is adjusted to ensure a uniform thickness of deposition. Where geometries dictate path plans that under- or over-build certain portions of the geometry, the path plans for subsequent layers may adjust, stagger, and/or offset (individually or in combination) to return the layer to a more uniform height. The location of the next layer to be deposited in the build height direction is also defined by the stagger and spacing of the layers below. As the offset is reduced from the nominal value, the height of a layer will be increased relative to its nominal height and vice versa. This is then accounted for in subsequent AM build layers.

In some embodiments, some exterior surfaces of the desired geometry are more critical or require greater smoothing than others. In these cases, the more critical surfaces may be created using a continuous build path whereas discontinuous build paths may be utilized for less critical surfaces.

In some embodiments, during the additive manufacturing step, the metal shaped-preform is additively manufactured with a continuous exterior build path such that via the additive manufacturing step, the metal shaped perform is sufficiently smooth to undergo a forging operation.

In some embodiments, during the additive manufacturing step, the metal shaped-preform is additively manufactured with a discontinuous exterior build path consisting of multiple continuous build paths which are located to maximize the length of each continuous segment such that, via the additive manufacturing step, the metal shaped perform is sufficiently smooth to undergo a forging operation (e.g. without forging defects).

In some embodiments, during the additive manufacturing step, the metal shaped-preform is additively manufactured with a continuous exterior build path such that via the additive manufacturing step, the metal shaped perform is sufficiently smooth to undergo a forging operation without undue defects.

In some embodiments, additive manufacturing technologies utilize path plans to define the location of individual “beads” of deposit which will combine to produce the desired deposit geometry. In some embodiments, these path plans create a series of paths that are largely similar in shape to adjacent paths such that the overlap between beads can be controlled and the entire geometry of the additively manufactured layer is covered in deposit. As such, the exterior profile of a layer may have to be approximated by stopping adjacent beads at different points such that they create the rough profile of a part. In some embodiments, this causes the formation of steps or jogs in the exterior surfaces of an additively manufactured deposit. The existence of these steps or jogs, depending on their size/magnitude, results in what is observed as surface roughness, or in the case of larger steps and jogs, in exterior surfaces of a deposit that are not smooth.

In some embodiments, the raised ridges and/or surface roughness are modified. In some embodiments the smoothing step imparts a change in surface morphology of the exterior walls of an additively manufactured deposit.

In some embodiments, path planning is configured to enhance manufacturing yield. In some embodiments, path planning is configured to improve the quality of the workable preform components. In some embodiments, path planning is configured to improve the mechanical properties of the workable preform. In some embodiments, the reduction of undulations in the surface of the deposit may also enhance the uniformity of the strain achieved in the forged component as the forging die will likely have a smooth surface and the “peaks” of the undulations would contact the die before any low spots on the deposit. In some embodiments, creating smoother exterior walls may also reduce (improve) stress concentrations in the final part (e.g. if the entire surface will not be machined before the part is put into service). In some embodiments, creating a smoother exterior wall may also allow for the additively manufactured deposits to be produced to a shape that is closer to the net-shape, reducing machining and material scrap.

In some embodiments, the elimination of the steps and jogs on the exterior of the additive build plan are sufficient to promote that there is proper die fill in the forging process. Moving the metal in these steps and jogs (i.e. without path planning) to form a smooth finished forging surface may not be possible, depending on the size of the step or jog. In cases where it is possible to move the metal and fill the die there is risk of folds and seams in these areas which are considered unacceptable defects in a forging. By using the path planning to achieve a continuous exterior surface, the forgeability of the preform will be improved. By smoothing the exterior surface it is possible to design preforms that will forge to match the desired part geometry with improved quality. In some embodiments, having a smooth exterior build also enable the final forged part to be closer to the desired geometry, improving material utilization (buy-to-fly).

In some cases, a continuous exterior build plan will be required to achieve an acceptable forged part.

In some cases, a smooth exterior surface will be required to achieve an acceptable forged part. This can be achieved through path planning as described in the previous paragraphs.

In some embodiments, the path planning detailed herein is specifically designed for and/or applied towards producing preforms suitable for a forging operation to eliminate defects and reduce material input. In other embodiments, path planning detailed herein is utilized in conjunction with post forming operations other than forging (e.g. shot peening and/or machining). In some embodiments, as path planning reduces material input (i.e. amount/quantity of feedstock utilized to make AM preform), AM preforms produce preforms or additive manufactured structures that are not forged. As detailed herein, and with reference to the comparative examples in each of FIGS. 14 and 15, the amount of excess material contained in the approximated stepped geometry may be significant. In some embodiments, path planning is used to reduce the amount of input stock used for an additively manufactured preform. One or more embodiments of path planning detailed in the present disclosure can be utilized to in the production of additively manufactured parts.

### Prophetic Example: Revised Path/Path Planning

AM builds produced via the directed energy deposition methods (EBAM, WAAM, plasma arc, laser, etc.) and extrusion methods involve depositing a bead of material along a length. To produce a preform or structure with a width that is wider than a single bead, successive beads are deposited next to one another (e.g. along a build plate/substrate) along an existing bead of material until the desired width is achieved. For parts with terminating edges (e.g. either a start or stop location for the bead), that is orthogonal (e.g. perpendicular) to the travel or deposition direction of the bead, the adjacent beads are able to line up. The terminating edge is essentially straight as each bead is terminated at the same location to create an essentially straight edge.

However, if the terminating edge of the part is not orthogonal (perpendicular) to the direction of bead travel then this skewed (angular/angled) edge needs to be approximated by staggering the termination of each adjacent bead. This approximation of the skewed edge plan results in a stair-step or discontinuous structure. For a finished forging shape that has a continuous skewed edge, each of these discontinuities presents an opportunity for forging defects to form as the termination point of one bead, intersect with mid-length portion of the adjacent bead. In this location the material will flow together during forging and can create laps, cold shuts, and/or seams in the forging, which are unacceptable conditions. Additionally, the stair step approximation of the skew surface may also cause forging voids or underfill as the material may not sufficiently fill the die in these locations due to the absence of material in the “vacancy” portion of the stair step.

The path planning for forging preforms described eliminates the “stair step” approximation of a continuous surface that is skewed to the deposition path. Instead of approximating the surface or path, metal is deposited in a skew orientation, enabling a surface that is sufficiently conformal to the forging die to prevent the forging defects that would be caused with the stair-step approximation of a skewed surface.

FIG. 13 depicts a side-by-side comparison of an as-made preform compared to an embodiment of a workable/forgeable preform configured with a smooth profile via path planning, in accordance with one or more methods of the instant disclosure.

FIG. 14 shows a vertical structure produced via an embodiment of additively manufacturing with path planning (right), wherein the vertical structure produced with path planning eliminates the stair steps in the vertical direction, ensuring a continuous external surface along the vertical outer mold line (as compared to the AM preform made without path planning (left)).

FIG. 15 depicts a star shaped pattern produced with the described path planning capabilities described herein, wherein the step pattern (depicted in the build pattern on the left schematic view of an AM preform) is eliminated and replaced by a continuous exterior surface (e.g. connected perimeter of a continuous bead/build from the AM feedstock) that is appropriate for forging (depicted at center). The image on the right depicts the reduction in stepped configuration (reduced discontinuities) when overlapping the left and center images, thereby highlighting the reduction of post-processing defects in the final part.

### Prophetic Example: Forging

A metal preform (titanium or otherwise) is produced using the selected additive manufacturing method (e.g. electron beam additive manufacturing (EBAM), wire arc additive manufacturing (WAAM), or other metal deposition or extrusion additive process).

With the proper path planning (e.g. varied AM bead path deposition to promote continuous profiles along the perimeter of the component) the metal preform is configured with a surface (e.g. reduced ridges, and/or lower surface roughness as compared to a non-smoothed AM surface with the same build parameters) and/or profile (e.g. appropriately filled corners and edges) sufficient to perform a forging operation. With the metal shaped-preform configured as a forgeable preform, additional processing steps (including but not limited to) mechanical grinding and/or chipping operations are reduced, prevented, and/or eliminated.

This AM produced preform will be the starting stock or blocker for the forging operation. The preform can be ready to be placed into the forging die without further rework. Once prepared, the forgeable preform is placed in a furnace to heat it to the appropriate forging temperature. At the same time the forging dies will also be heated to the appropriate temperature for forging. The temperature for both of metal preform (forgeable metal preform) and the forging die are dependent on the type of metal and the geometry (e.g. determined prior to the forging operation).

With the dies at the appropriate temperature and the preforms at the appropriate temperature, the preforms will be removed from the furnace and placed within the forging die. The forging dies are then compressed together forcing the metal in the preform to redistribute and fill the die cavity. This forging action can occur in a single pressing operation. It may also be accomplished through multiple pressing operations (or blows) until the die impression is filled.

The preform is heated, forged in the dies, and then removed from the dies so that the part can undergo further/subsequent operations (as required) for the specific part. These subsequent operations could include placing back into the furnace for a subsequent forging operation or allowing the part to cool for preparation for other forging steps or thermal operations like heat treating, annealing, and/or aging. The subsequent operations may also include rework operations. The cycle of placing a preform in the furnace, heating to the desired temperature, placing in the die for forging, forging to the desired geometry for that step and then removing from the die is considered a forging step. A single step forging would be defined as heating and forging the material in a press (a single press) with multiple blows. A multiple step forging would be defined as repeating the forging step multiple times.

In some embodiments, the final forged product is configured with an amount (e.g., a pre-selected amount) of true strain due to the contacting step 220. In some embodiments, the strain realized by the final forged product may be non-uniform throughout the final forged product due to, for example, the shape of the forging dies and/or the shape of the metal shaped-preform. Thus, the final forged product may realize areas of low and/or high strain. Accordingly, the building substrate may be located in a predetermined area of the metal shaped-preform such that after the forging, the building substrate is located in a predetermined area of low strain of the final forged product. In some embodiments (e.g. when the substrates are wrought), the substrates are configured to achieve the desired properties without additional strain. In some embodiments, an area of low strain is predetermined based on predictive modeling and/or empirical testing. In some embodiments, based on modeling, the strain distribution within the final forging is predicted. In some embodiments, through design and analysis of the metal shaped-preform, the desired amount of strain in the final forging is pre-determined. In some embodiments, the pre-determined amount of strain is utilized/configured such that the final forged component achieves the desired properties. As such, the substrate is configured/located in an area outside of the final component in the forging such that work is not required in that region.

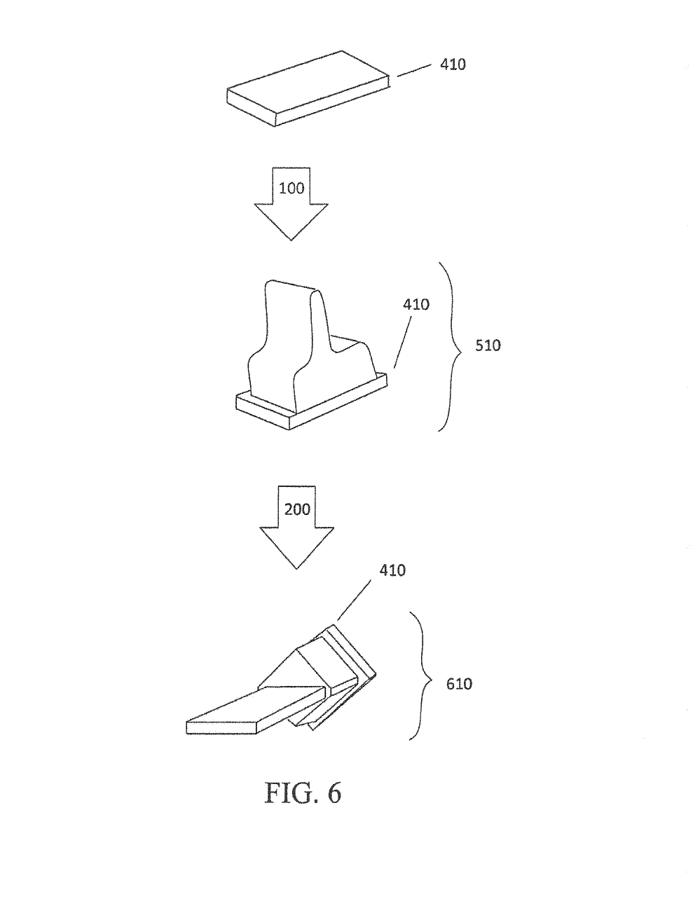

Referring now to FIG. 6, another embodiment of incorporating a building substrate (410) into a metal shaped-preform (510) is shown. In the illustrated embodiment, material is added to the building substrate (410) via additive manufacturing (100) to produce the metal shaped-preform (510). In this embodiment, the metal shaped-preform (510) is forged (200) into a final forged product (610). In this embodiment, the final forged product (610) includes the building substrate (410) as an integral piece. In another embodiment, the metal shaped-preform is removed from the building substrate prior to the forging step.

In some embodiments, the building substrate is configured with a predetermined shape and/or predetermined mechanical properties (e.g., strength, toughness to name a few). In one embodiment, the building substrate is a pre-wrought base plate. In one embodiment, the shape of the building substrate is predetermined based on the shape of the area of low strain. In one embodiment, the mechanical properties of the building substrate are predetermined based on the average true strain realized by the metal shaped-preform and/or the true strain realized within the area of low strain. In one embodiment, two or more building substrates are incorporated into a metal-shaped preform. In one embodiment, the building substrate comprises a pre-wrought base plate. In one embodiment, the building substrate was produced using an additive manufacturing process. In one embodiment, multiple metal shaped-preforms are built upon the same build substrate and separated after the additive manufacturing step and prior to the forging step.

In some embodiments, the building substrate is configured/made from any metal suited for both additive manufacturing and forging, including, for example metals or alloys of titanium, aluminum, nickel (e.g., INCONEL), steel, titanium aluminide, and stainless steel, among others. In one embodiment, the building substrate is made of the same material(s) as the rest of the metal-shaped preform. In one embodiment, the material added to the metal shaped preform is a first material, whereas the building substrate is made of a second material (where the second material is different from the first material). In one embodiment, the first material is configured with a first strength and the second material is configured with a second strength. In one embodiment, the first material has a first fatigue property and the second material has a second fatigue property. In some embodiments, the first material is different form than the second material (e.g. powder on plate, wire on plate, etc.)

In one example, the building substrate is a first ring of a first material. A second material is added, via additive manufacturing, to the ring thereby forming a second ring of the second material, integral with the first ring. Thus, a ring-shaped metal shaped-preform comprising two different materials is produced. In this example, the ring-shaped metal shaped-preform is then forged into a ring-shaped final forged product comprising two different materials.

In one embodiment, one or more engine containment rings (e.g., one or more aerospace engine containment rings) is formed by the method described above. For example, the building substrate includes a first ring of a material which realizes high toughness. Then, a second ring of a second material which realizes high strength is added, via additive manufacturing, to the first ring thereby forming a metal shaped-preform. In this embodiment, the metal shaped-preform is then forged into an engine containment ring having an inner ring of high toughness and outer ring of high strength.

In some embodiments, additive manufacturing is utilized to produce gradient materials. In this embodiment, the resultant metal shaped-preform comprises a gradient structure achieved through the additive manufacturing process by varying the composition of the additive feedstock and/or the process parameters during deposition of the metal shaped-preform.

### Example 1—Ti-6Al-4V

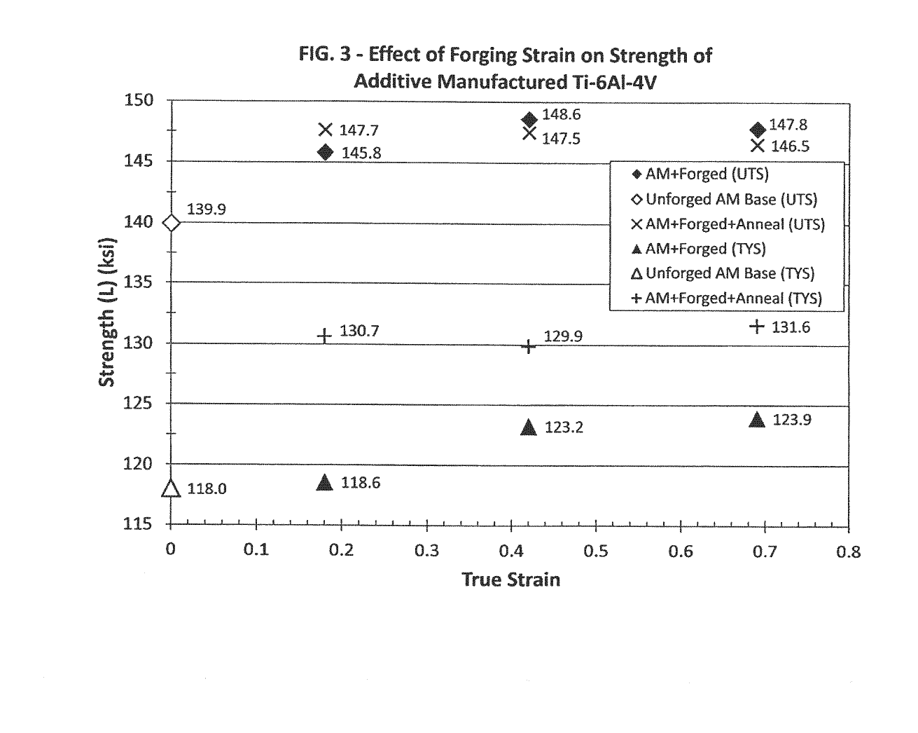

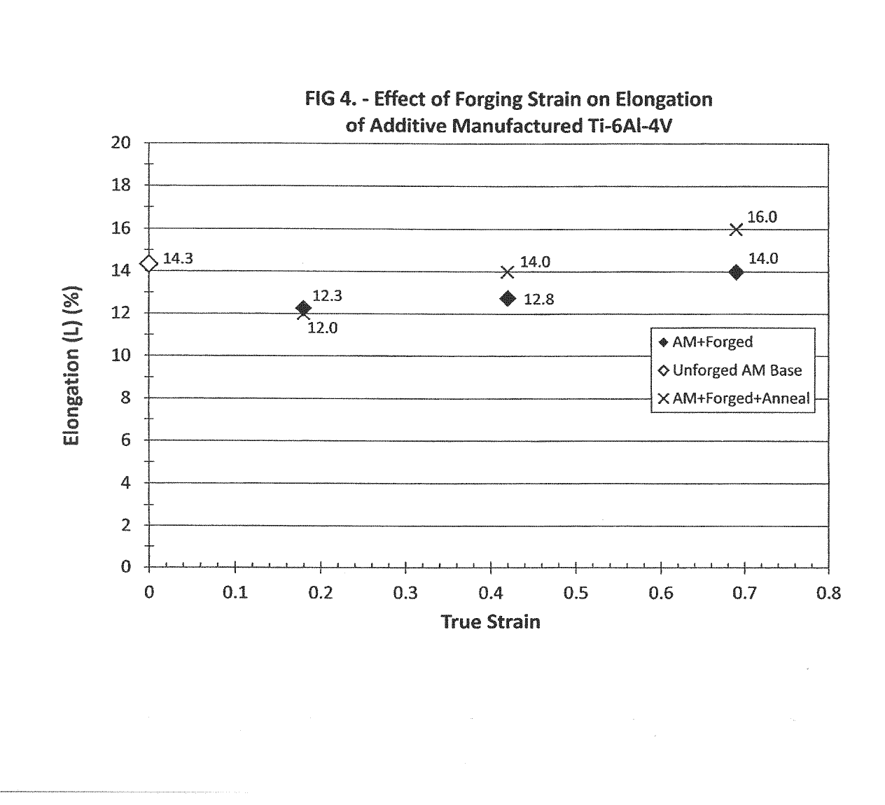

Several Ti-6Al-4V preforms are produced via additive manufacturing. Specifically cylindrical Ti-6Al-4V preforms were produced via an EOSINT M 280 Direct Metal Laser Sintering (DMLS) additive manufacturing system, available from EOS GmbH (Robert-Stirling-Ring 1, 82152 Krailling/Munich, Germany). The Ti-6Al-4V preforms were produced in accordance with the manufacturer's standard recommended operating conditions for titanium. The preforms were then heated to a stock temperature of about 958° C. (1756° F.) or about 972° C. (1782° F.). Next, some of the cylindrical preforms were forged under various amounts of true strain and using a die temperature of about 390° C.-400° C. (734° F.-752° F.) to produce cylindrical final forged products. The true strain was applied to the cylindrical preforms in a direction parallel to the axis of the cylinders. The remaining preforms were left unforged. Some of the final forged products were then annealed at a temperature of about 732° C. (1350° F.) for approximately two hours to produce annealed final forged products. Mechanical properties of the unforged preforms, the final forged products, and the annealed final forged products were then tested, including tensile yield strength (TYS), ultimate tensile strength (UTS) and elongation, all in the L direction, the results of which are shown in FIGS. 3-4. For each level of strain, several samples were tested and the results were averaged. Mechanical properties, including TYS, UTS, and elongation were tested in accordance with ASTM E8.

As shown, the forged Ti-6Al-4V products achieved improved properties over the unforged Ti-6Al-4V preforms. Specifically, and with reference to FIG. 3, the forged Ti-6Al-4V products achieved improved ultimate tensile strength (UTS) over the unforged Ti-6Al-4V preforms. For example, the unforged Ti-6Al-4V preforms achieved a UTS of about 140 ksi. In contrast, the forged Ti-6Al-4V products achieved improved ultimate tensile strength, realizing a UTS of about 149 ksi after being forged to a true strain of about 0.4. Furthermore, and as shown in FIG. 3, the forged Ti-6Al-4V products achieved improved tensile yield strength (TYS) over the unforged Ti-6Al-4V preforms. For example, the unforged Ti-6Al-4V preforms achieved a TYS of about 118 ksi. In contrast, the forged Ti-6Al-4V products achieved improved tensile yield strength, realizing a TYS of about 123 ksi after being forged to a true strain of about 0.4. As shown in FIG. 4, the forged Ti-6Al-4V products achieved good elongation, all achieving an elongation of above 12% after being forged.

Furthermore, the annealed final forged products achieved improved properties over the final forged products which were not annealed. Specifically, and with reference to FIG. 3, the annealed final forged products achieved improved tensile yield strength (TYS) over the non-annealed final forged products. For example the annealed final forged products which were forged to a true strain of about 0.2 achieved a TYS approximately 10% higher than the final forged products which were not annealed. Furthermore, and as shown in FIG. 3, the annealed final forged products achieved similar ultimate tensile strength (UTS) to the non-annealed final forged products. Thus, annealing the final forged products increased TYS without sacrificing UTS. As shown in FIG. 4, the annealed final forged products achieved improved elongation compared to the non-annealed final forged products.

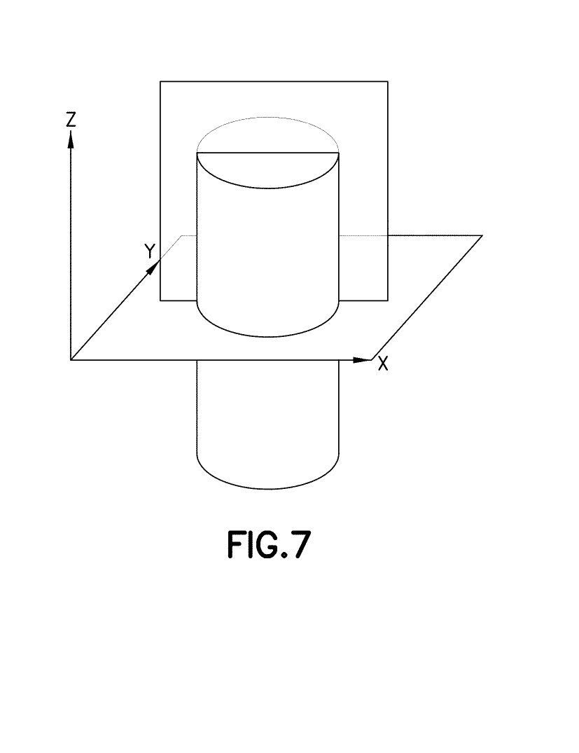

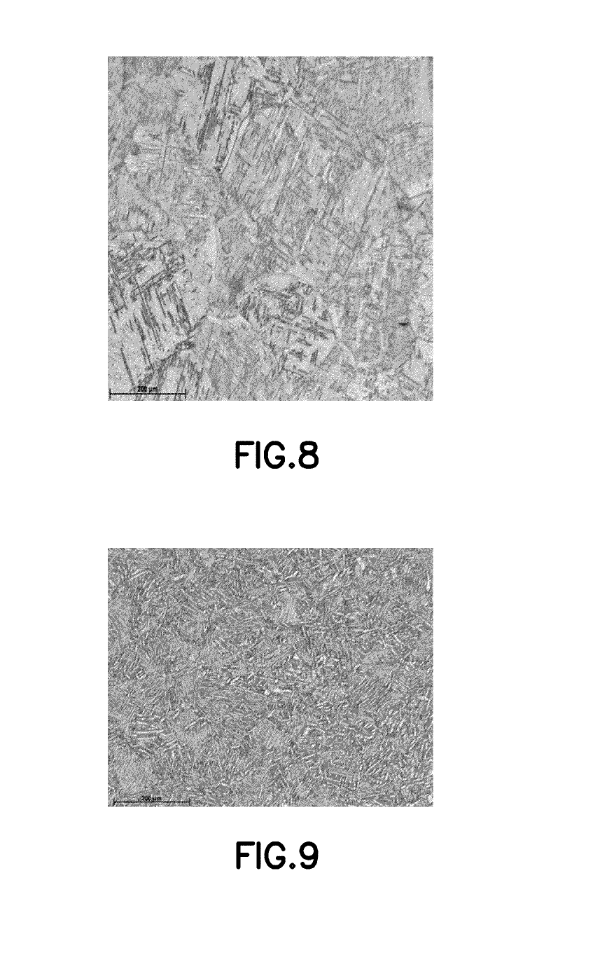

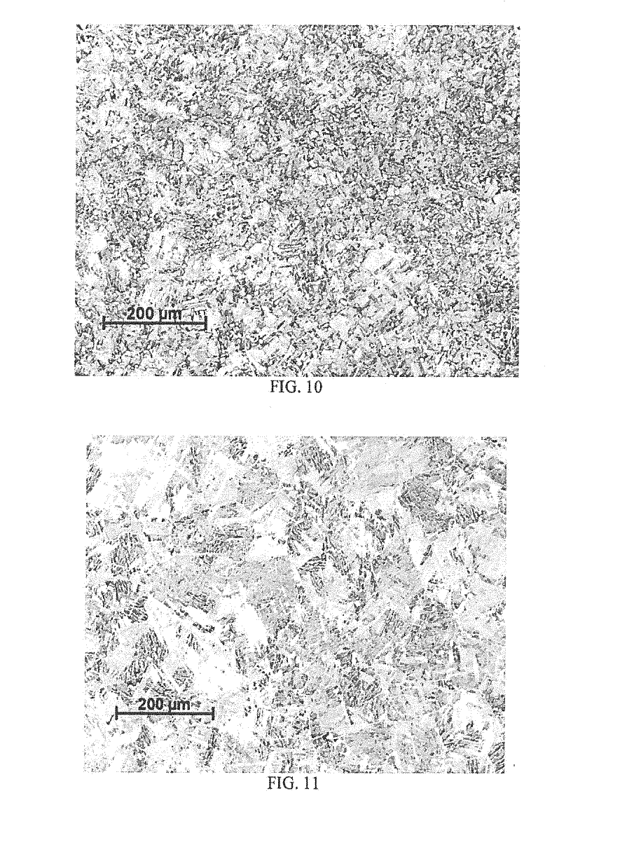

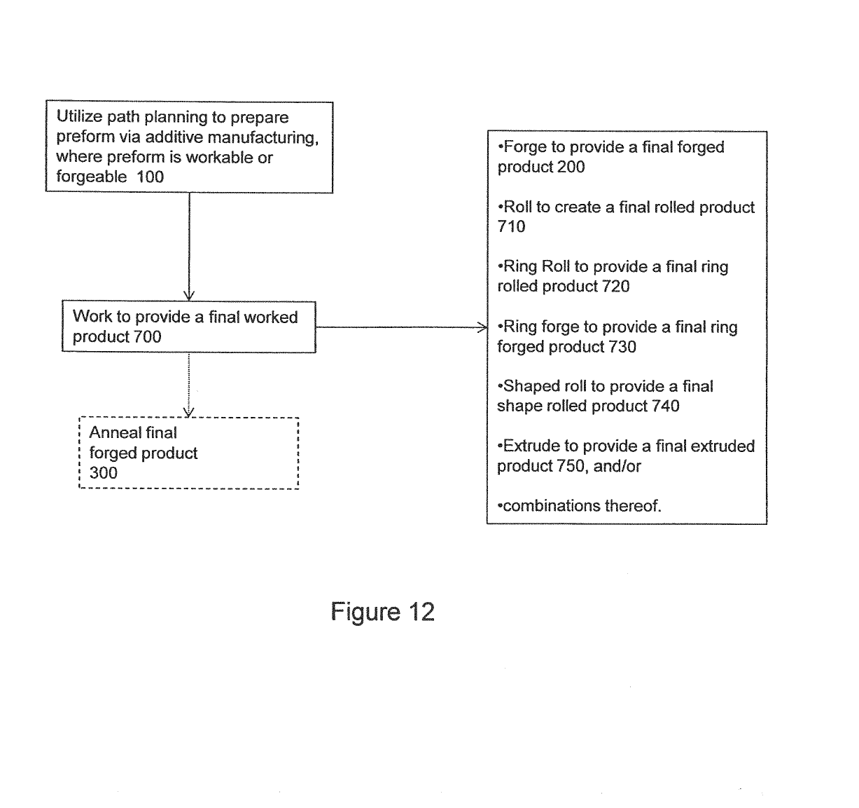

FIGS. 8-11 are micrographs showing the microstructures of the cylindrical preforms and cylindrical final forged products of Example 1. All of the micrographs were taken in the transverse orientation and at the midpoint of the cylinder. Referring now to FIG. 7, one embodiment of a cylindrical final forged product is illustrated. In the illustrated embodiment, the final forged product has been forged in the Z direction. The X-Y plane shown in FIG. 7 is the transverse orientation and the X-Z plane is the longitudinal orientation. Referring back to FIG. 8, a micrograph of a Ti-6Al-4V preform produced via additive manufacturing is shown. As can be seen in FIG. 8, the microstructure consists of transformed beta phase material with evidence of the prior beta phase grains. FIG. 9 is a micrograph of a additively manufactured Ti-6Al-4V preform that has been preheated to a temperature of about 1750° F. As can be seen in FIG. 9, the microstructure after heating is transformed beta phase material with the formation and growth of acicular alpha phase material. No primary alpha phase material is observed. FIG. 10 is a micrograph of an additively manufactured Ti-6Al-4V preform that has been preheated to a temperature of about 1750° F. and then forged to true strain of about 0.7 (e.g., a final forged product). As can be seen in FIG. 10 the preheating and forging steps result in a more refined grain structure, punctuated by the nucleation of primary alpha phase grains interspersed in the matrix. These interspersed primary alpha phase grains are observed as the small, white, circular dots. FIG. 11 is a micrograph of an additively manufactured Ti-6Al-4V preform that has been preheated to a temperature of about 1750° F., then forged to true strain of about 0.7, and then annealed at a temperature of about 1350° F. (e.g., an annealed final forged product). As can be seen in FIG. 11, in addition to the small, circular grains of primary alpha phase material interspersed in the matrix, primary grains of alpha phase material have formed as well.

While various embodiments of the present disclosure have been described in detail, it is apparent that modification and adaptations of those embodiments will occur to those skilled in the art. However, it is to be expressly understood that such modifications and adaptations are within the spirit and scope of the present disclosure.

What is claimed is:

1. A method comprising:
(a) additively manufacturing a metal shaped-preform from an additive manufacturing feedstock;
(b) concomitant with (a), using a bead deposition strategy to modify a bead path, whereby the combination of (a) and (b) provide the metal shaped preform configured with a smoothed external surface having non-stepped walls as compared to the metal shaped preform without such bead deposition strategy; and
(c) performing at least one post processing operation on the metal shaped preform to form a final formed product, whereby, due to (b), the final formed product has reduced post processing operation defects as compared to without (b).

2. The method of claim 1, wherein the bead deposition strategy comprises path planning of the bead path.

3. The method of claim 2, wherein path planning is selected from the group consisting of:
a. a non-linear build path around the interior of a part build;
b. a non-linear build path around the perimeter of a part build;
c. an overlapping bead deposition in the build direction, when comparing a first AM deposition layer to a subsequent AM deposition layer, wherein each deposition layer is configured from a plurality of beads, such that between the first AM deposition layer and the subsequent AM deposition layer, a subsequent layer bead does not completely overlap with a first layer bead, and
d. combinations thereof.

4. The method of claim 1, wherein the bead deposition strategy comprises path planning, wherein a first bead in a first AM build layer overlaps at least a portion but not entirely with a subsequent bead in a subsequent AM build layer, wherein the subsequent bead is in contact with the first bead.

5. The method of claim 1, wherein the post processing operation is selected from the group consisting of: forging, thermally treating and machining, machining, shot peening, annealing, and combinations thereof.

6. The method of claim 1, wherein the additively manufacturing is completed with a directed energy deposition additive machine.

7. The method of claim 6, wherein the direct energy deposition additive machine is selected from the group consisting of: a Sciaky machine, plasma arc machine, a wire feed AM machine, and combinations thereof.

8. The method of claim 1, wherein the post processing operation is forging and the final formed product is free from forging defects selected from the group consisting of: folds, cavities, and combinations thereof.

9. The method of claim 1, further comprising:
a. machining the final forged part to provide a finished part.

10. The method of claim 1, wherein the metal preform comprises at least one of titanium, titanium alloy, titanium aluminide, aluminum, nickel, steel, and stainless steel.

11. The method of claim 1, wherein the bead deposition strategy is configured in a vertical direction such that the vertical surfaces are free from defect-causing discontinuities in the post processing operation.

12. The method of claim 1, wherein the bead deposition strategy is configured in a horizontal direction such that the horizontal surfaces are free from defect-causing discontinuities in the post processing operation.

13. A method, comprising:
a. additively manufacturing a metal shaped-preform from an additive manufacturing feedstock using a direct energy deposition additive machine;
b. utilizing path planning deposition strategy to promote a non-stepped perimeter of the metal shaped preform, and
c. forging the metal shaped preform to form a final forged product, whereby via (b) the final forged product is substantially free from forging defects including at least one of: laps, cavities, folds, cold shuts, and combinations thereof.

14. The method of claim 13, wherein path planning further comprises utilizing a modified bead deposition in successive layers of the metal shaped preform such that the bead deposition layers are non-conforming to provide a different build pattern layer-by-layer within the metal shaped preform.

15. The method of claim 13, wherein path planning further comprises utilizing a modified bead deposition in successive layers of the metal shaped preform such that the bead deposition layers are overlapping by less than 100%.

16. The method of claim 15, wherein bead overlap is less than 80% between two beads of successive AM build layers.

17. The method of claim 15, wherein the bead overlap is less than 50% between two beads of successive AM build layers.

18. The method of claim 15, wherein the bead overlap is less than 30% between two beads of successive AM build layers.

19. The method of claim 13, whereby the metal shaped preform is configured with a smoothed surface, characterized by the absence of jogs and steps in the build height direction, configured in the direction normal from the build plane.

20. The method of claim 13, wherein the path planning deposition strategy is configured in a vertical direction such that the vertical surfaces are free from defect-causing discontinuities in the forging step.

21. The method of claim 13, wherein the path planning deposition strategy is configured in a horizontal direction such that the horizontal surfaces are free from defect-causing discontinuities in the forging step.

22. The method of claim 13, the forging step comprises a single die forging step.

23. The method of claim 13, wherein the metal preform comprises at least one of titanium, titanium alloy, titanium aluminide, aluminum, nickel, steel, and stainless steel.

24. The method of claim 13, wherein the forging step comprises:
a. heating the metal shaped-preform to a stock temperature; and
b. contacting the metal shaped-preform with a forging die.

25. The method of claim 13, wherein after the utilizing step (b), working the metal shaped-preform into a final worked product via at least one of: (i) rolling, (ii) ring rolling, (iii) ring forging, (iv) shaped rolling, (v) extruding, and (vi) combinations thereof.

26. The method of claim 13 comprising, after the forging step (c), annealing the final forged product.
